(19) United States
(12) Patent Application Publication
(10) Pub. No.: US 2010/0077152 A1
(43) Pub. Date: Mar. 25, 2010

(54) PRIMARY-SECONDARY CACHING SCHEME TO ENSURE ROBUST PROCESSING TRANSITION DURING MIGRATION AND/OR FAILOVER

(75) Inventor: Ankur Jain, Cupertino, CA (US)

Correspondence Address: Weaver Austin Villeneuve & Sampson - Yahoo!, P.O. BOX 70250, OAKLAND, CA, 94612-0250, US

(73) Assignee: YAHOO! INC., Sunnyvale, CA (US)

(21) Appl. No.: 12/237,322

(22) Filed: Sep. 24, 2008

(51) Int. Cl. G06F 12/08

(52) U.S. Cl. 711/133; 711/E12.017

(57) ABSTRACT

Scores are maintained usable by a behavioral targeting service. Each of a plurality of scoring engine partitions is provided events (first events) for at least one of the particular non-overlapping subsets of the users, and at least one particular scoring engine partition is also provided events (second events) for at least an additional one of said particular non-overlapping subsets of the users. The event indications are processed to determine updated scoring data indicative of behavior of the users represented by the detected events relative to the at least one online service and the updated scoring data are written to a persistent scoring engine storage. The particular scoring engine provides updated scores to the persistent scoring engine storage according to a first writeback caching scheme for updated scores determined from the first events and according to a second writeback caching scheme for updated scores determined from the second events. The time-to-live parameters are controlled for the first writeback caching scheme independently of controlling time-to-live parameters for the second writeback caching scheme.

### CROSS REFERENCE TO RELATED APPLICATIONS

This application is related to co-pending U.S. application Ser. No. ______, filed on an even date herewith, entitled “STORAGE OPTIMIZATION FOR UPDATED USER BEHAVIORAL PROFILE SCORES” (Atty. Docket No.: YAH1P167), and to co-pending U.S. application Ser. No. ______, filed on an even date herewith, entitled “DATED METADATA TO SUPPORT MULTIPLE VERSIONS OF USER PROFILES FOR TARGETING OF PERSONALIZED CONTENT” (Atty. Docket No.: YAH1P168), both of which are incorporated herein by reference in their entirety for all purposes.

### BACKGROUND

FIG. 1, which does not illustrate the present invention, illustrates an architecture of a system in which front end web servers FEa 102a, FEb 102b, FEc 102c, . . . , FEx 102x, including front end web servers handling search events, are producing event data 105 based on incoming user requests 103. There may be many types of events. For example, a web portal such as provided by Yahoo, Inc. may include numerous different “sites,” such as “Sports,” “Finance” and “Search.” These are just a few examples of possible sites and, in practice, the portal may include many more sites.

In the FIG. 1 architecture, the event data 105 is provided to data collectors DC 1 108(1) and DC2 108(2) via paths Pa 106a, Pb 106b, Pc 106c and Pd 106d. In general, there may be numerous front end web servers, data collectors and paths; a small number are shown in FIG. 1 and throughout this patent description for simplicity of illustration. The particular paths may be determined according to a path configuration 104, for example, as described in U.S. patent application Ser. No. 11/734,067 (Attorney Docket number YAH1P079), filed on Apr. 11, 2007. U.S. patent application Ser. No. 11/734,067 is incorporated by reference at least for its disclosure of methods to determine path configurations.

The data collectors may be, for example, computers or computer systems in one or more data centers. A data center is a collection of machines (data collector machines) that are co-located (i.e., physically proximally-located). The data centers may be geographically dispersed to, for example, minimize latency of data communication between front end web servers and the data collectors. Within a data center, the network connection between machines is typically fast and reliable, as these connections are maintained within the facility itself. Communication between front end web servers and data centers, and among data centers, is typically over public or quasi-public networks (i.e., the internet).

The events provided from the front end web servers to the data collectors may be provided to one or more data warehouses, using a construct known by some as a “data highway.” In some examples, the data highway has “off ramps” via which various events may be detected and used for functions such as generating scores for use in targeting advertisements to users based on past behavior of the users.

### SUMMARY

Scores are maintained that are usable by a behavioral targeting service. Event indications are processed, wherein the event indications being processed are indicative of interaction by users generally with at least one online service. Some of the event indications are indicative of events usable for generating scoring data for behavioral targeting for providing personalized content. The processing of event indications is to detect event indications that are indicative of events usable for generating scoring data for behavioral targeting. The users include a plurality of particular non-overlapping subsets of users.

Each of the detected event indications is provided to a separate one of a plurality of scoring engine partitions of a scoring engine, each scoring engine partition is provided detected events for at least one of the particular non-overlapping subsets of the users, and at least one scoring engine partition also being provided detected events for at least an additional one of said particular non-overlapping subsets of the users.

Each of the plurality of scoring engine partitions processing the detected event indications provided to that scoring engine partition to determine, based at least in part thereon, updated scoring data indicative of behavior of the users represented by the detected events relative to the at least one online service and writing the updated scoring data to a persistent scoring engine storage. The at least one scoring engine partition is provided detected events for at least an additional one of said particular non-overlapping subsets of the users provides updated scores to the persistent scoring engine storage according to a first writeback caching scheme for updated scores determined from detected events for a first of the particular non-overlapping subsets of the users and according to a second writeback caching scheme for updated scores determined from detected events for the additional one of the particular non-overlapping subsets of the users.

In addition, the time-to-live parameters are controlled for the first writeback caching scheme independently of controlling time-to-live parameters for the second writeback caching scheme.

### BRIEF DESCRIPTION OF THE DRAWINGS

FIG. 1, which does not illustrate the present invention, illustrates an architecture of a system in which event indications, generated as a result of user interaction with online services, is provided to data collectors, for providing to persistent storage, such as in a data warehouse.

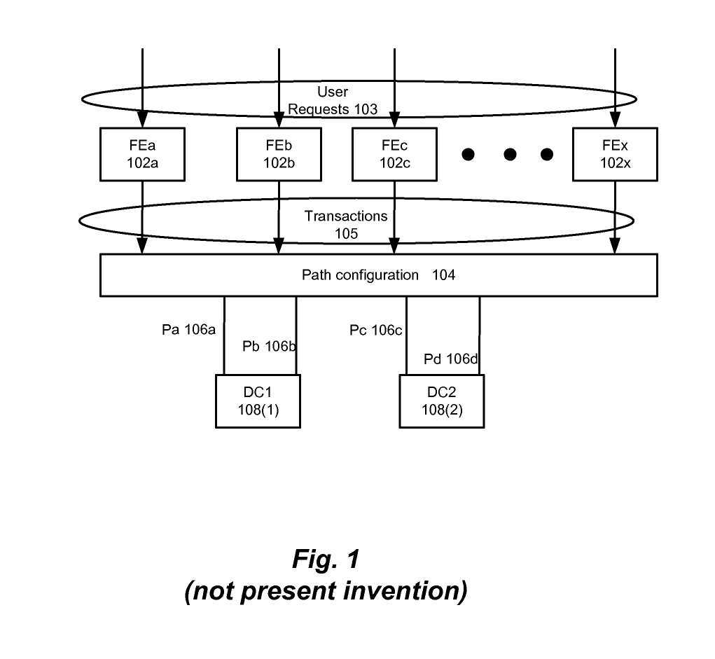

FIG. 2 illustrates how event indications may be provided to a scoring engine as the event indications are provided for persistent storage.

FIG. 3 broadly illustrates an architecture of a system including a scoring engine that generates updated targeting scores, saves the updated scores to an internal score storage using a writeback cache mechanism, and also and provides updated scores to online data stores at targeting data centers.

FIG. 4 is a diagram of an example targeting-centric logical architecture.

FIG. 5 illustrates an architecture for a scoring engine including a cache mechanism, in accordance with an example.

FIG. 6 is a flowchart illustrating an example method to handle a planned migration of some processes to another server, with respect to caching of data resulting from the processing to be migrated.

FIG. 7 is a timeline showing, over time, how the TTL parameters for a cache for scores determined from “primary” events may be controlled independently of TTL parameters for scores determined from “secondary” events.

FIG. 8 is a simplified diagram of a network environment in which specific embodiments of the present invention may be implemented.

### DETAILED DESCRIPTION

The inventors have realized the desirability of controlling caching parameters of a writeback cache for storing scores updated by a primary scoring engine partition independently of controlling caching parameters of a writeback cache for storing scores updated by secondary scoring engine partitions. In general, each scoring engine partition is the primary scoring engine partition for a subset of the events. When any particular scoring engine partitions fails or it is otherwise determined that it should not be used, the processing load for the subset of the events that would be handled by that scoring engine partition is distributed to other available scoring engine partitions, which each operate as a secondary processing partition for those events. When the primary scoring engine partition is available again, the scoring engine partition resumes processing events as a primary scoring engine partition, i.e., assuming the processing from the secondary scoring engine partition. The inventors have addressed the issue of migrating the state (cached in a writeback cache in the scoring engine partition) with minimal loss when the processing moves from the secondary scoring engine partition to the primary scoring engine partition.

Thus, for example, processing of events can be migrated to a different serving engine partition with little loss of updated data that has been cached by zeroing out the time-to-live parameters for the writeback caching, to cause any cached updated scores to be written to persistent storage. Meanwhile, the time-to-live parameters for caching updated scores from primary events need not be zeroed, thus no unduly increasing the traffic to memory for processing of primary events, which will not be similarly migrated.

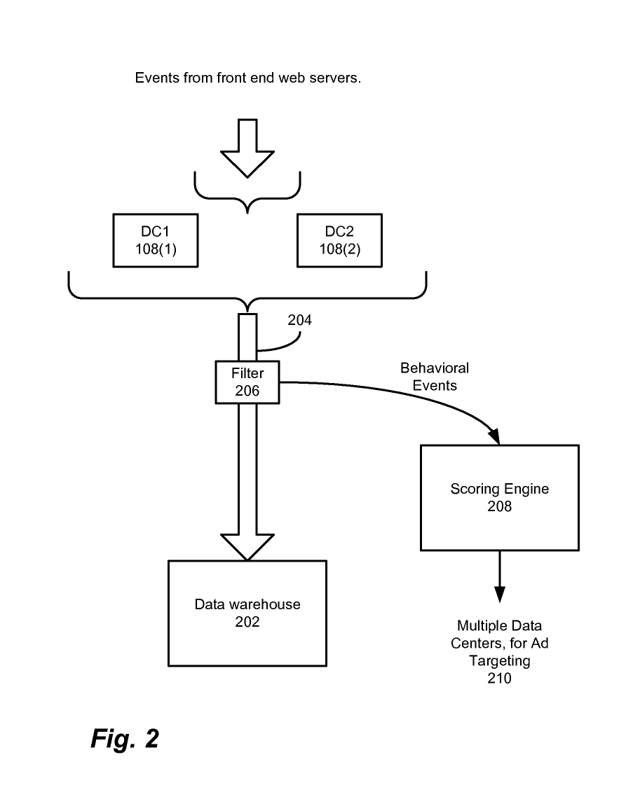

Referring now to FIG. 2, the event data provided to the data collectors DC1 108(1) and DC2 108(2) via paths Pa 106a, Pb 106b, Pc 106c and Pd 106d are further provided to a data warehouse 202 via what may be thought of as a “data highway” 204. For example, every event may be indicated by an event record that includes fields whose contents characterize the event. For example, an event record may include a field whose contents identify a “host name” or “space id” corresponding to a front end server that that generated the event. A “space id” is a unique key that identifies the page contents and category. In addition, the event record may include a “user id” that uniquely correlates to a particular user. Particular events that satisfy particular criteria may be provided from the data highway, as they are provided for persistent storage, using a data offramp. More particularly, the data offramp operates as a selector to select events on the data highway that satisfy the particular criteria.

A scoring engine 208 may then use the “behavioral events” to generate scores for particular users in particular categories, where the generated scores are representative of the behavior of the particular users with respect to those particular categories. Thus, for example, the generated scores may be utilized by targeting functionality to target each particular user with advertisements based on how that user has previously interacted with the sites of the web portal and how that user is presently interacting with the sites of the web portal. This behavioral-based targeting may be used in combination with targeting based on demographic information of the user, as well as geographic information of the user. That is, when a user requests a particular web page, a score for that user, where the score is associated with a category to which the requested particular web page corresponds, may be processed to determine an advertisement to display to that user in association with the requested particular web page. Generally, the better targeted the web page is to the user's past behavior (i.e., to behavior with respect to web pages in the same category as the particular web page requested by the user), the higher a price the web page publisher may command from the advertiser. The general concept of scoring and targeting is well known.

The advertisements are served from geographically-distributed data centers 210. The targeting scores are thus provided to multiple data centers 210 for use in the advertisement targeting process.

The inventor has realized that the process of computing and updating user scores to multiple data centers can be highly bandwidth intensive. For example, one portal may result in as many as eight billion events per day, which would result in updating the scores at the multiple data centers eight billion times per day. It may be advantageous to maintain an “internal” state of the scores and to update the scores at the multiple data centers only when particular criteria are met, such as when an internal score for a user has changed such that, if available at the data centers, the advertisement determination behavior for that user would be different than if the score were not updated. Thus, for example, the number of updates may be as few as five hundred million per day, rather than eight billion updates per day. An example of this is described in co-pending U.S. application Ser. No. ______ (Atty. Docket No.: YAH1P167).

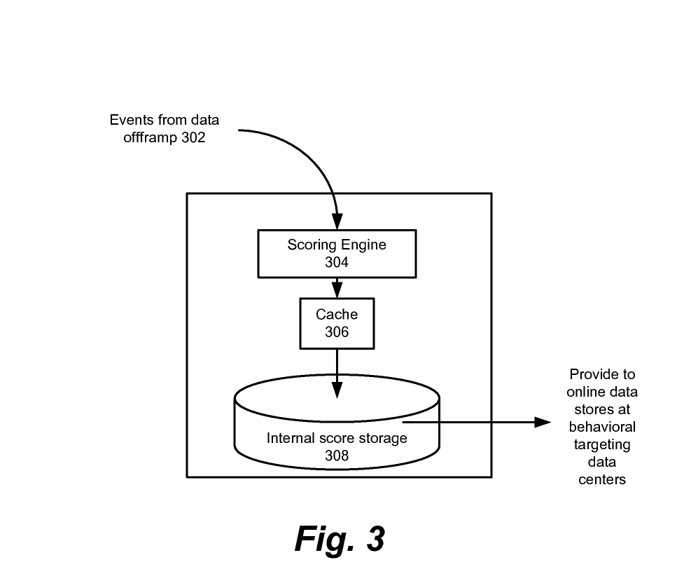

FIG. 3 illustrates a block diagram of an architecture in which an internal state is maintained in an internal score storage, and in which updates are provided to an online data store as appropriate. Referring to FIG. 3, events from the data offramp 302 are provided to the scoring engine 304, which determines updated scores. The updated scores are held in a writeback cache 306 according to writeback cache configuration parameters and, also according to writeback cache configuration parameters, are provided to the internal score storage 308 as appropriate. In addition, the updated scores are provided as appropriate to online data stores, as mentioned above. Writeback caching schemes are known and include, in particular, a caching method in which modifications to data in the cache are not copied to main memory until an appropriate time, such as indicated by time-to-live parameters associated with the caching scheme. In contrast, a write-through cache performs all write operations in parallel—data is written to main memory and the cache simultaneously. Write-back caching yields somewhat better performance than write-through caching because it reduces the number of write operations to main memory. With this performance improvement comes a risk, however, that data may be lost if the system crashes before the data has been written to memory.

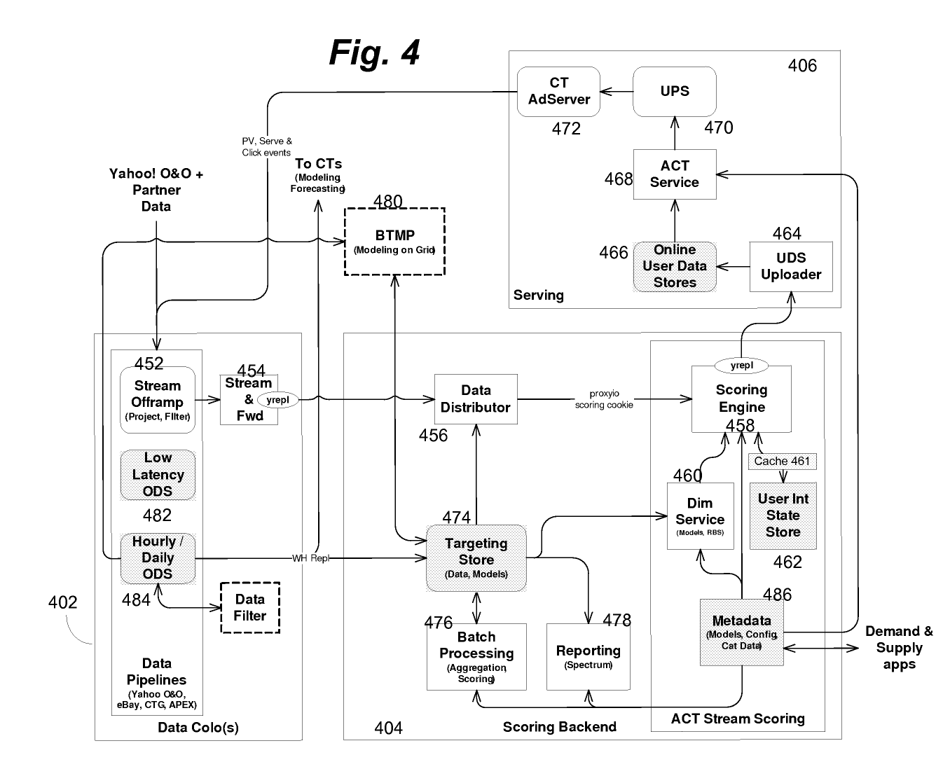

Components that may be used in an example targeting-centric logical architecture are shown in FIG. 4. Broadly speaking, a data center 402 is the source of events being provided for persistent storage. A scoring center 404 processes the events affecting scores used for advertisement targeting, and an advertisement targeting center 406 determines how to target users with advertisements. (In a typical example, the advertisement targeting center 406 is actually multiple distributed advertisement targeting centers 406.) More particularly, a data highway off-ramp 452 of the data center 402 receives data highway events with various parameters that characterize the events. Stream and forward components 454 are co-located with the data highway off-ramps 452, collecting the user activity data from the off-ramps 452 and forwarding the user activity data to a data distributor 456 of the scoring data center 404 using, in this specific example, a “yrepl” event, which is an event that is provided using a particular protocol that is understood by both the data center 402 and the scoring center 404. The data distributor 456 of the scoring center 404 provides the event to a scoring engine 458 of the scoring center 404. The scoring engine 458 queries a dimension service 460 to get information about the scoring model via which to update a score based on the received event. The dimension service 460 holds the model data. The scoring engine 458 then retrieves the current score, whether from local writeback cache 461 or directly from a user internal state store 462 maintained at the scoring center 404. Metadata 486 provides information about the models, such as which model to use, how to configure the scoring engine 458, etc.

The scoring engine 458 updates the score based on the received event, according to the appropriate scoring model. Then the scoring engine 458 determines if the updated score should be provided to the serving center 406. If the scoring engine 458 determines that the updated score should be provided to the serving center 406, then the updated user score is provided, using a yrepl message, to a user data store uploader 464 of the serving center 406, which handles uploading the updated score to the online data stores 466, where it is available for use by the behavior targeting functionality of the serving centers 406.

Still referring to FIG. 4, in the serving center 506, the ACT (Audience Centric Targeting) Service component 468 applies final decays, score adjustments, combinations, etc to the score components in the user profile. The UPS (User Profile Service) component 470 is a brokering service that federates calls for targeting/personalization data across multiple stores and/or services. The CT (Connection Tactic) server component 472 performs ad matching and serving for a Connection Tactic (Guaranteed Delivery, Non guaranteed delivery, etc).

We now turn to the components that are more relevant to the raw data of the received events. For example, the targeting store component 474 is an operational data store containing raw events (pageviews, adviews, adclicks, etc) that are provided from operational data stores for various data collection pipelines from multiple data collection services, that are used by the targeting systems. For example, the low latency operational data store (ODS) 482 and hourly/daily ODS 484 are operational data stores that provide data feeds to various (internal) consumers and to the targeting store component 474. Low latency ODS has data available at latencies of 1 h or less while the hourly/daily ODS provides at latencies of two hours or more. The data retention in this store is typically twenty-eight days or lower. The batch processing component 476 does daily aggregation on this raw data and these daily aggregations are provided to the scoring engine 458 in addition to streaming events. The reporting component 478 is an internal reporting system usable to inspect how well scoring models are performing.

The Behavioral Targeting Modeling Platform (BTMP) 480 is a modeling component that uses data from the targeting store 474 to generate models that may be used for research and/or for generating models for the production system.

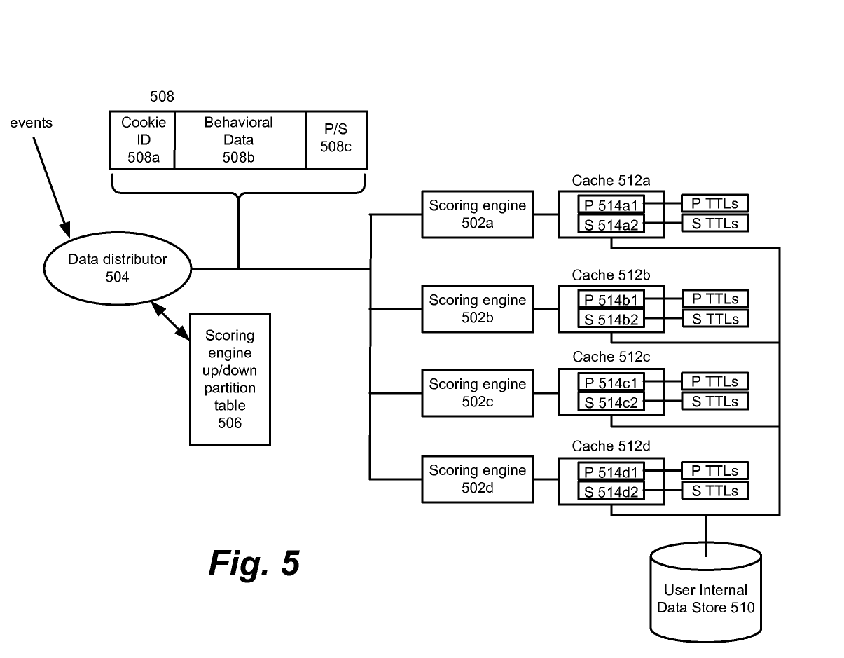

We now discuss, with reference to FIG. 5, how the functionality of the scoring engine 458 may be partitioned among multiple computing devices. In FIG. 5, the multiple computing devices are the scoring engine partitions 502 (in FIG. 5, scoring engine partitions 502a-502d, though in practice there may be many more such scoring engine partitions 502). Events (such as from the stream and forward component 454 (FIG. 4) are distributed by a data distribution component 504 to the scoring engine partitions 502. The data distribution component 504 may, for example, use a hash table to effect the distribution of events to the scoring engine partitions 502. Generally, the distribution of events is such that all events for a particular user (as indicated in the received event) are handled wholly by a respective particular scoring engine partition.

In addition, the data distribution component 504 may operate according to a scoring engine partition “up/down” table 506, which indicates which scoring engine partitions 502 are available and which are unavailable (e.g., due to failure or maintenance). Thus, for example, if the hash table or other distribution mechanism indicates that an event is to be handled (primarily) by a particular score engine partition 502, and that particular scoring engine partition 502 is indicated as unavailable in the “up/down” table 506, then the event may be provided to a scoring engine partition 502 (a “secondary” scoring engine partition, for events for the user for which the provided event is associated) that can handle the event until the primary scoring engine partition 502 becomes available or is replaced. It is noted that, generally, a particular scoring engine partition 502, if the scoring engine partition 502 is a secondary scoring engine partition for events for some users, that particular scoring engine partition 502 is also a primary scoring engine partitions for events for some other users.

In one example, the event is provided by the data distribution component 504 to a scoring engine 502 in a particular format such as the format 508. According to the format 508, the provided event includes a field for the “cookie ID” 508a, which uniquely corresponds to a particular user; for “behavioral data” 508b, which is the actual data being used by the scoring engine partition 502 to generate an updated score; and a flag that indicates if the destination scoring engine partition 502 is primary or secondary for events for particular user from whom the event resulted.

Each scoring engine partition 502 operates to generate updated scores to be stored in a data store 510, such as the user internal state store 462 (FIG. 4). Furthermore, each scoring engine partition 502 includes a writeback cache 512. Each writeback cache 512 is logically organized into a primary cache and a secondary cache. For example, writeback cache 512a is logically organized into primary cache 514a1 and secondary cache 514a2. Keeping with the example of writeback cache 512a, the cache mechanism is such that the primary cache 514a1 is used for caching updated scores determined for events for which the scoring engine partition 502a is primary. On the other hand, the secondary cache 514a2 is used for caching updated scores determined for events for which the scoring engine partition 502a is secondary.

The caching mechanism of the primary cache 514a1 and of the secondary cache 514a2 may be separately controlled by, for example, providing separate sets of TTL (time to live) parameters for each cache. TTL parameters govern the amount of time that the cached data may be used in processing, until the data is stored persistently in the corresponding memory. In the scoring application, besides that it could be come unwieldy to keep too many scores in cache, due to the typically limited size of this expensive resource, if the cache contents are lost (e.g., due to a failure of the corresponding computing device), then the corresponding value stored in the persistent store may not be sufficiently up to date. Operationally, in determining the TTL parameters, it may be a tradeoff between the risk of losing updated scoring values that have been cached and the increased cost of storing updated values to memory (as opposed to the relatively lower cost of working directly from the cache).

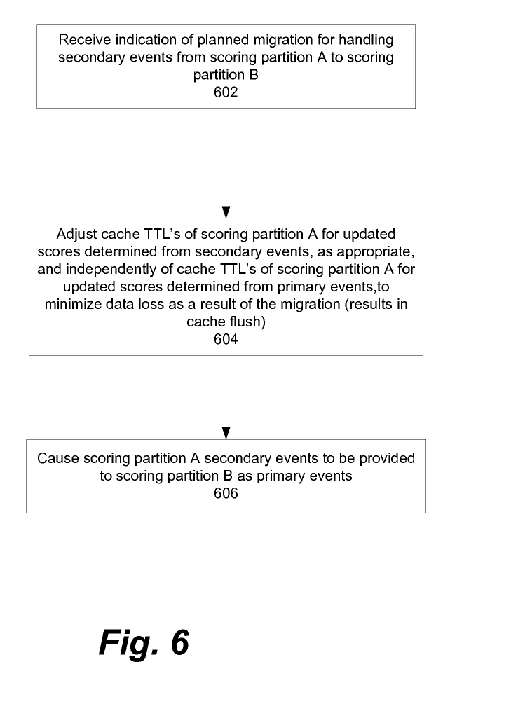

In the case, though, in which a migration is planned (as opposed to resulting from a failure), then the TTL configurations can be adjusted for the cache holding those updated scores based on the events to be migrated, so as to minimize or eliminate the amount of lost updated scores from the writeback cache that will no longer be used. FIG. 6 is a flowchart illustrating an example method of accomplishing such a planned migration. At 602, an indication is received of a planned migration for handling of secondary events, from a first scoring engine partition “A” to a second scoring engine partition “B.” At 604, the cache TTL's are adjusted for the secondary cache for scoring engine partition A, to minimize the loss of data when the secondary cache for scoring engine partition A are no longer used due to scoring partition B handling events as primary events. The cache TTL's for the secondary cache for scoring engine partition A are independently adjustable relative to the cache TTL's for the primary cache for scoring engine partition A. At 606, the data distribution component is configured such that events that were previously secondary events provided to scoring partition A are instead primary events provided to scoring partition B.

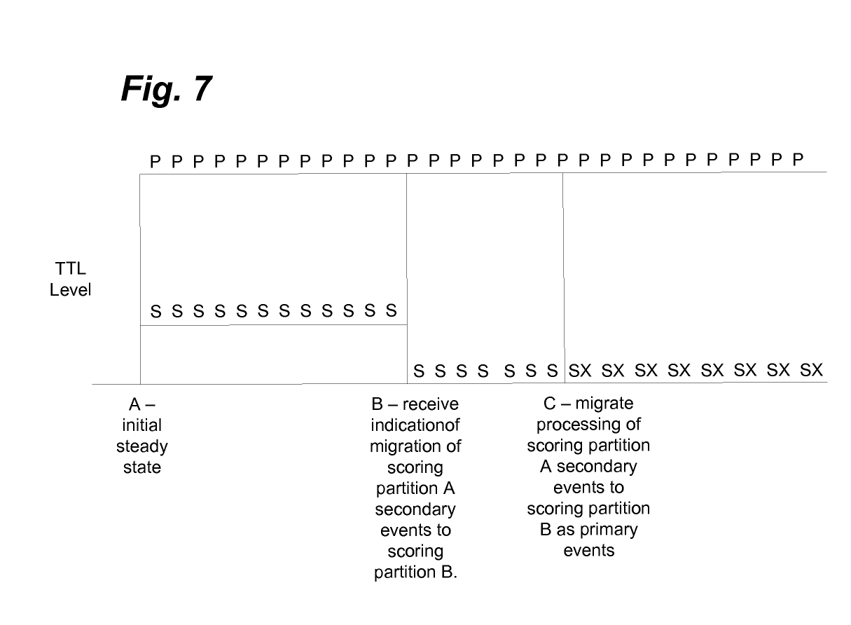

FIG. 7 is a timeline illustrating an example of the cache TTL's for scoring engine partition A for the example method illustrated by FIG. 6. At time A, the TTL's for the primary cache (indicated by “P”) are at a particular value, whereas the TTL's for the secondary cache (indicated by “S”) are at a lower particular value. At time B, the TTL's for the secondary cache are lowered to zero, based on an indication that events that were previously secondary events provided to scoring partition A are instead going to be provided as primary events to a scoring partition other than scoring partition A. At time C, the events that were previously secondary events provided to scoring partition A are no longer provided to scoring partition A. Thus, at time C, the TTL's for the secondary cache are a “don't care,” indicated in FIG. 7 as “SX.” It can thus be seen that, by allowing the primary cache parameters and secondary cache parameters to be independently controlled, each can be set at what may be judged to be appropriate or optimal. For example, as mentioned above, it may be desirable to keep the primary cache TTL's relatively high, to lower the memory bandwidth load that would be used to save updated scores directly to the memory, all the while realizing the risk of losing data should the scoring partition fail while the primary cache has “dirty” data that has not yet been written to persistent storage. On the other hand, it may be desirable to, at a planned migration, lower the secondary cache TTL's (or even the primary cache TTL'S, if it is planned to migrate the primary events to another scoring partition) to zero prior to the planned migration, in order to minimize or eliminate “dirty” data that would otherwise be in the cache at the migration.

Since the migration is planned, the effect on memory bandwidth during the transition can be minimized by shortening the time period between which the TTL's are lowered to zero and the migration takes place. Also, while the use of memory bandwidth for updated scores based on the to-be migrated events is temporarily increased for the to-be migrated events, the use of memory bandwidth is maintained at an otherwise optimal level for updated scores based on events that will not be migrated.

While the discussion above has focused on a caching mechanism used by scoring engine partitions in the process of generating and storing updated scores that are usable for behavioral targeting of advertisements, other examples are possible. As just some examples, the values being updated need not be scores that are usable for behavioral targeting of advertisements but, rather, may be any type of values that are being updated. As another example, while the above description describes a primary and secondary cache, the number and character of caches need not be so limited.

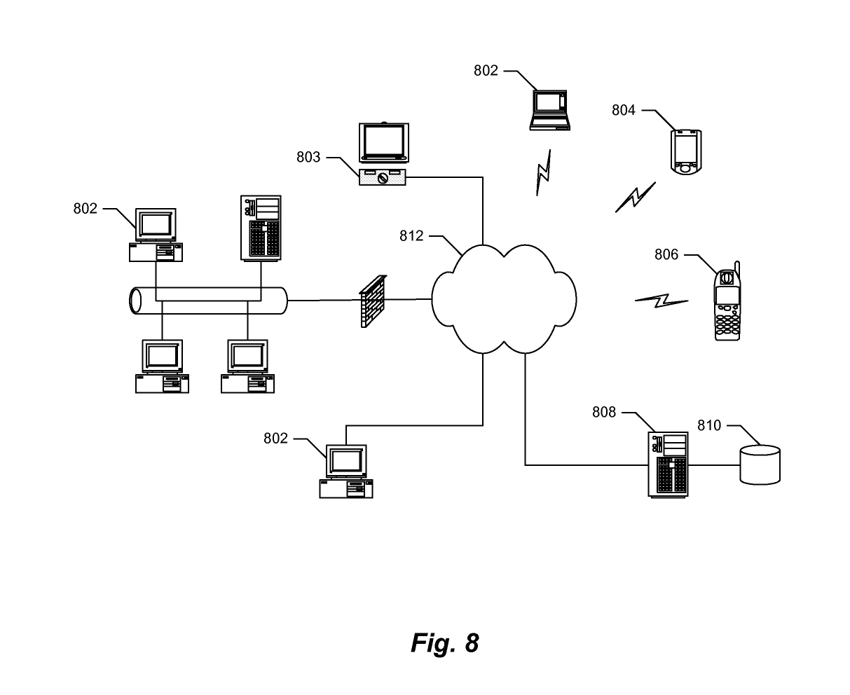

Embodiments of the present invention may be employed to configure presence indications in a wide variety of computing contexts. For example, as illustrated in FIG. 8, implementations are contemplated in which users may interact with a diverse network environment via any type of computer (e.g., desktop, laptop, tablet, etc.) 802, media computing platforms 803 (e.g., cable and satellite set top boxes and digital video recorders), handheld computing devices (e.g., PDAs) 804, cell phones 806, or any other type of computing or communication platform.

According to various embodiments, applications may be executed locally, remotely or a combination of both. The remote aspect is illustrated in FIG. 8 by server 808 and data store 810 which, as will be understood, may correspond to multiple distributed devices and data stores.

The various aspects of the invention may also be practiced in a wide variety of network environments (represented by network 812) including, for example, TCP/IP-based networks, telecommunications networks, wireless networks, etc. In addition, the computer program instructions with which embodiments of the invention are implemented may be stored in any type of tangible computer-readable media, and may be executed according to a variety of computing models including, for example, on a stand-alone computing device, or according to a distributed computing model in which various of the functionalities described herein may be effected or employed at different locations.

What is claimed is:

1. A method of maintaining scores usable by a behavioral targeting service, comprising:
processing event indications, wherein the event indications being processed are indicative of interaction by users generally with at least one online service, wherein some of the event indications are indicative of events usable for generating scoring data for behavioral targeting for providing personalized content, the processing of event indications to detect event indications that are indicative of events usable for generating scoring data for behavioral targeting, and wherein the users include a plurality of particular non-overlapping subsets of users;
providing each of the detected event indications to a separate one of a plurality of scoring engine partitions of a scoring engine, each scoring engine partition being provided detected events for at least one of the particular non-overlapping subsets of the users, and at least one scoring engine partition also being provided detected events for at least an additional one of said particular non-overlapping subsets of the users;
by each of the plurality of scoring engine partitions,
processing the detected event indications provided to that scoring engine partition to determine, based at least in part thereon, updated scoring data indicative of behavior of the users represented by the detected events relative to the at least one online service and writing the updated scoring data to a persistent scoring engine storage,
wherein the at least one scoring engine partition being provided detected events for at least an additional one of said particular non-overlapping subsets of the users provides updated scores to the persistent scoring engine storage according to a first writeback caching scheme for updated scores determined from detected events for a first of the particular non-overlapping subsets of the users and according to a second writeback caching scheme for updated scores determined from detected events for the additional one of the particular non-overlapping subsets of the users,
the method further comprising controlling time-to-live parameters for the first writeback caching scheme independently of time-to-live parameters for the second writeback caching scheme.

2. The method of claim 1, wherein:
the at least one scoring engine partition being provided detected events for at least an additional one of said particular non-overlapping subsets of the users is a current scoring engine partition;
the method further comprises
receiving an indication that the detected events for at least an additional one of said particular non-overlapping subsets of the users providing to the current scoring engine partition are to be migrated to be provided to a different scoring engine partition, that is one of the plurality of scoring engine partitions, instead of to the current scoring engine partition;
in response to the indication, adjusting the time-to-live parameters for the second writeback caching scheme of the current scoring engine partition; and
providing the detected events for the at least additional one of said particular non-overlapping subsets of the users to the different scoring engine partition instead of to the current scoring engine partition.

3. The method of claim 2, wherein:
adjusting the time-to-live parameters for the second writeback caching scheme of the current scoring engine partition includes adjusting the time-to-live parameters for the second writeback caching scheme of the current scoring engine partition to zero.

4. The method of claim 1, wherein:
the providing step is based at least in part on an indication of an ability of the serving engine partitions to process detected events.

5. The method of claim 1, wherein:
the providing step includes indicating whether a provided event is a detected event for at least one of the particular non-overlapping subsets of the users or one of the detected events for the at least an additional one of said particular non-overlapping subsets of the users.

6. A method of operating a scoring engine service that comprises a plurality of scoring engine partitions, to maintain scores usable by a behavioral targeting service, the method comprising:
by each of the plurality of scoring engine partitions, receiving detected event indications indicative of interaction by users with at least one online service, each scoring engine partition being provided events for at least one of a plurality of non-overlapping subsets of the users, and at least one scoring engine partition also being provided events for at least an additional one of said non-overlapping subsets of the users;
by each of the plurality of scoring engine partitions,
processing event indications provided to that scoring engine partition to determine, based at least in part thereon, updated scoring data indicative of behavior of the users represented by the events relative to at least one online service and writing the updated scoring data to a persistent scoring engine storage,
wherein the at least one scoring engine partition being provided event indications for at least an additional one of said particular non-overlapping subsets of the users provides updated scores to the persistent scoring engine storage according to a first writeback caching scheme for updated scores determined from detected events for a first of the particular non-overlapping subsets of the users and according to a second writeback caching scheme for updated scores determined from detected events for the additional one of the particular non-overlapping subsets of the users,
the method further comprising controlling time-to-live parameters for the first writeback caching scheme independently of time-to-live parameters for the second writeback caching scheme.

7. The method of claim 6, wherein:
the at least one scoring engine partition being provided detected events for at least an additional one of said particular non-overlapping subsets of the users is a current scoring engine partition;
the method further comprises
receiving an indication that the detected events for at least an additional one of said particular non-overlapping subsets of the users providing to the current scoring engine partition are to be migrated to be provided to a different scoring engine partition, that is one of the plurality of scoring engine partitions, instead of to the current scoring engine partition;
in response to the indication, adjusting the time-to-live parameters for the second writeback caching scheme of the current scoring engine partition; and
providing the detected events for the at least additional one of said particular non-overlapping subsets of the users to the different scoring engine partition instead of to the current scoring engine partition.

8. The method of claim 7, wherein:
adjusting the time-to-live parameters for the second writeback caching scheme of the current scoring engine partition includes adjusting the time-to-live parameters for the second writeback caching scheme of the current scoring engine partition to zero.

9. The method of claim 6, wherein:
the providing step is based at least in part on an indication of an ability of the serving engine partitions to process detected events.

10. The method of claim 6, wherein:
the providing step includes indicating whether a provided event is a detected event for at least one of the particular non-overlapping subsets of the users or one of the detected events for the at least an additional one of said particular non-overlapping subsets of the users.

11. A system to maintain scores usable by a behavioral targeting service, comprising:
an event indication detector that processes event indications, wherein the event indications being processed are indicative of interaction by users generally with at least one online service, wherein some of the event indications are indicative of events usable for generating scoring data for behavioral targeting for providing personalized content, the processing of event indications to detect event indications that are indicative of events usable for generating scoring data for behavioral targeting, and wherein the users include a plurality of particular non-overlapping subsets of users;
a scoring engine comprising a plurality of scoring engine partitions;
an event indication provider that provides each of the detected event indications to a separate one of the plurality of scoring engine partitions of the scoring engine, each scoring engine partition being provided detected events for at least one of the particular non-overlapping subsets of the users, and at least one scoring engine partition also being provided detected events for at least an additional one of said particular non-overlapping subsets of the users;
wherein each of the plurality of scoring engine partitions is configured to:
process the detected event indications provided to that scoring engine partition to determine, based at least in part thereon, updated scoring data indicative of behavior of the users represented by the detected events relative to the at least one online service and writing the updated scoring data to a persistent scoring engine storage,
wherein the at least one scoring engine partition being provided detected events for at least an additional one of said particular non-overlapping subsets of the users provides updated scores to the persistent scoring engine storage according to a first writeback caching scheme for updated scores determined from detected events for a first of the particular non-overlapping subsets of the users and according to a second writeback caching scheme for updated scores determined from detected events for the additional one of the particular non-overlapping subsets of the users, and
control time-to-live parameters for the first writeback caching scheme independently of time-to-live parameters for the second writeback caching scheme.

12. A computer program product comprising a tangible computer-readable medium having computer program instructions tangibly embodied thereon to configure a plurality of scoring engine partitions of a scoring engine service to maintain scores usable by a behavioral targeting service, the computer program instructions tangibly embodied on the tangible computer-readable medium operable to:
configure each of the plurality of scoring engine partitions to receive detected event indications indicative of interaction by users with at least one online service, each scoring engine partition being configured to receive events for at least one of a plurality of non-overlapping subsets of the users, and at least one scoring engine partition also being configured to receive events for at least an additional one of said non-overlapping subsets of the users;
configure each of the plurality of scoring engine partitions, process event indications provided to that scoring engine partition to determine, based at least in part thereon, updated scoring data indicative of behavior of the users represented by the events relative to at least one online service and provide the updated scoring data to a persistent scoring engine storage,
configure the at least one scoring engine partition configured to receive event indications for at least an additional one of said particular non-overlapping subsets of the users, provide updated scores to the persistent scoring engine storage according to a first writeback caching scheme for updated scores determined from detected events for a first of the particular non-overlapping subsets of the users and according to a second writeback caching scheme for updated scores determined from detected events for the additional one of the particular non-overlapping subsets of the users; and
configure the scoring engine service such that the time-to-live parameters for the first writeback caching scheme are controllable independently of time-to-live parameters for the second writeback caching scheme.

13. The computer program product of claim 12, wherein:
the at least one scoring engine partition being configured to receive detected events for at least an additional one of said particular non-overlapping subsets of the users is a current scoring engine partition;
the computer program instructions are operable to cause the scoring engine service to:
receive an indication that the detected events for at least an additional one of said particular non-overlapping subsets of the users received by the current scoring engine partition are to be migrated to be received by a different scoring engine partition, that is one of the plurality of scoring engine partitions, instead of to the current scoring engine partition;
in response to the indication, adjust the time-to-live parameters for the second writeback caching scheme of the current scoring engine partition; and
receive the detected events for the at least additional one of said particular non-overlapping subsets of the users by a different scoring engine partition instead of by the current scoring engine partition.

14. The computer program product of claim 13, wherein:
adjusting the time-to-live parameters for the second writeback caching scheme of the current scoring engine partition includes adjusting the time-to-live parameters for the second writeback caching scheme of the current scoring engine partition to zero.
